(19) United States
(12) Patent Application Publication
(10) Pub. No.: US 2025/0275575 A1
(43) Pub. Date: Sep. 4, 2025

(54) AEROSOL-GENERATING DEVICE AND HEATING STRUCTURE

(71) Applicant: SMOORE INTERNATIONAL HOLDINGS LIMITED, George Town (KY)

(72) Inventors: Lei MA, Shenzhen (CN); Hongming ZHOU, Shenzhen (CN); Rihong LI, Shenzhen (CN); Xianwu DU, Shenzhen (CN); Guo ZHANG, Shenzhen (CN); Yaobin HU, Shenzhen (CN)

(21) Appl. No.: 19/211,064

(22) Filed: May 16, 2025

Related U.S. Application Data
(63) Continuation of application No. PCT/CN2023/114117, filed on Aug. 21, 2023.

(30) Foreign Application Priority Data
Nov. 17, 2022 (CN) 202211442112.3

(51) Int. Cl. A24F 40/46; H05B 1/02

(52) U.S. Cl. CPC A24F 40/46; H05B 1/0252; H05B 2203/003

(57) ABSTRACT

A heating structure includes: a sleeve; a heating element at least partially spaced apart from the sleeve, the heating element including a heating substrate configured to generate heat in a powered-on state; and an infrared radiating layer arranged on an outer surface of the heating substrate for radiating infrared light waves. The sleeve allows the infrared light waves to pass through. The heating element is at least partially bent and has a first free end and a second free end. The sleeve has two end portions distributed along a longitudinal direction. The first free end and the second free end are led out from a same end portion of the sleeve.

### CROSS-REFERENCE TO PRIOR APPLICATION

This application is a continuation of International Patent Application No. PCT/CN2023/114117, filed on Aug. 21, 2023, which claims priority to Chinese Patent Application No. 202211442112.3, filed on Nov. 17, 2022. The entire disclosure of both applications is hereby incorporated by reference herein.

### FIELD

The present disclosure relates to the field of heat-not-burn atomization, and more specifically, to an aerosol-generating device and a heating structure.

### BACKGROUND

In the field of heat-not-burn (HNB) atomization, generally, heating methods such as central heater heating or peripheral heater heating are adopted. Typically, a heating element is powered up to generate heat, and then the heat is directly transferred to a substrate such as an aerosol generating substrate through heat conduction. The substrate is generally atomized at a temperature not exceeding 350° C. However, the drawback of this heating method is that: the heating element transfers the heat directly or indirectly through a solid material to the substrate such as the aerosol generating substrate, requiring the heating element to operate within a controlled temperature range. If the temperature is too high, overheating of the substrate may be caused, adversely affecting the vaping experience.

In the related technology, there are certain heating structures generating infrared light waves for heating, and the heating element of the heating structure operates at approximately 400° C. However, a conductive element of such heating structure is introduced from a base into a sleeve of the heating structure to connect the heating element, resulting in a complex assembly process of the heating structure. In addition, a heating structure with a maximum operating temperature of higher than 400° C. has not been reported in existing research.

### SUMMARY

In an embodiment, the present invention provides a heating structure, comprising: a sleeve; a heating element at least partially spaced apart from the sleeve, the heating element comprising a heating substrate configured to generate heat in a powered-on state; and an infrared radiating layer arranged on an outer surface of the heating substrate and configured to radiate infrared light waves, wherein the sleeve is configured to be allow the infrared light waves to pass through, wherein the heating element is at least partially bent and has a first free end and a second free end, wherein the sleeve has two end portions distributed along a longitudinal direction, and the first free end and the second free end are led out from a same end portion of the sleeve.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic structural diagram of an aerosol-generating device according to a first embodiment of the present disclosure;

FIG. 2 is a schematic structural diagram of a heating structure in the aerosol-generating device shown in FIG. 1;

FIG. 3 is a cross-sectional view of the heating structure shown in FIG. 2;

FIG. 4 is an exploded view of the heating structure shown in FIG. 2;

FIG. 5 is a schematic structural diagram of a heating element in the heating structure shown in FIG. 4;

FIG. 6 is a horizontal cross-sectional view of the heating element shown in FIG. 5;

FIG. 7 is a horizontal cross-sectional view of a heating element in an aerosol-generating device according to a second embodiment of the present disclosure;

FIG. 8 is a horizontal cross-sectional view of a heating element in an aerosol-generating device according to a third embodiment of the present disclosure;

FIG. 9 is a schematic structural diagram of a heating structure in an aerosol-generating device according to a fourth embodiment of the present disclosure;

FIG. 10 is a schematic structural diagram of the heating structure shown in FIG. 9 in another view;

FIG. 11 is a cross-sectional view of the heating structure shown in FIG. 9;

FIG. 12 is an exploded view of the heating structure shown in FIG. 9;

FIG. 13 is a schematic structural diagram of a heating portion in an aerosol-generating device according to a fifth embodiment of the present disclosure;

FIG. 14 is a schematic structural diagram of a heating portion in an aerosol-generating device according to a sixth embodiment of the present disclosure;

FIG. 15 is a schematic structural diagram of a heating portion in an aerosol-generating device according to a seventh embodiment of the present disclosure;

FIG. 16 is a schematic structural diagram of a heating portion in an aerosol-generating device according to an eighth embodiment of the present disclosure;

FIG. 17 is a schematic structural diagram of a heating portion in an aerosol-generating device according to a ninth embodiment of the present disclosure;

FIG. 18 is a schematic structural diagram of a heating element in an aerosol-generating device according to a tenth embodiment of the present disclosure;

FIG. 19 is a schematic structural diagram of a heating element in an aerosol-generating device according to an eleventh embodiment of the present disclosure;

FIG. 20 is a schematic structural diagram of a heating element in an aerosol-generating device according to a twelfth embodiment of the present disclosure;

FIG. 21 is an exploded view of the heating element shown in FIG. 20;

FIG. 22 is a schematic structural diagram of a heating element in an aerosol-generating device according to a thirteenth embodiment of the present disclosure;

FIG. 23 is a cross-sectional view of a heating structure in an aerosol-generating device according to a fourteenth embodiment of the present disclosure;

FIG. 24 is an exploded view of the heating structure of the aerosol-generating device shown in FIG. 23;

FIG. 25 is a cross-sectional view of a heating structure in an aerosol-generating device according to a fifteenth embodiment of the present disclosure; and

FIG. 26 is an exploded view of the heating structure of the aerosol-generating device shown in FIG. 25.

### DETAILED DESCRIPTION

In an embodiment, the present invention provides an improved aerosol-generating device and a heating structure.

In an embodiment, the present invention provides a heating structure, including a sleeve and a heating element at least partially spaced apart from the sleeve. The heating element includes a heating substrate that generates heat in a powered-on state, and an infrared radiating layer which is arranged on the outer surface of the heating substrate and configured to radiate infrared light waves. The sleeve is configured to allow the infrared light waves to pass through; the heating element is at least partially bent and has a first free end and a second free end; the sleeve has two end portions distributed along the longitudinal direction; and the first free end and the second free end are led out from the same end portion of the sleeve.

In some embodiments, the heating element includes a plurality of bent segments, and the plurality of bent segments are arranged at intervals.

In some embodiments, the plurality of bent segments are distributed at equal intervals.

In some embodiments, the plurality of bent segments are distributed densely and sparsely alternately.

In some embodiments, the plurality of bent segments are distributed sparsely first and then densely.

In some embodiments, the plurality of bent segments are distributed densely first and then sparsely.

In some embodiments, the plurality of bent segments are distributed sparsely first, then densely, and sparsely finally.

In some embodiments, the plurality of bent segments are distributed densely first, then sparsely, and densely finally.

In some embodiments, the heating element includes a first heating portion and a second heating portion; and the first heating portion is wrapped on the periphery of the second heating portion.

In some embodiments, the second heating portion has a linear shape; and
the first heating portion includes at least one bent segment.

In some embodiments, the first free end is arranged at one end of the first heating portion and is configured to form a conductive portion; and the second free end is arranged at one end of the second heating portion and is configured to form another conductive portion.

In some embodiments, the first heating portion and the second heating portion are of a separate structure.

In some embodiments, the first heating portion and the second heating portion are of an integral structure.

In some embodiments, the first heating portion and the second heating portion are in insulated configuration;
and/or the first free end and the second free end are in insulated configuration.

In some embodiments, the outer wall of the first heating portion and/or the outer wall of the second heating portion are/is provided with an insulation structure.

In some embodiments, the insulation structure includes an air gap, or includes an insulation layer applied to the outer surface of the first heating portion and/or the outer surface of the second heating portion.

In some embodiments, the insulation structure includes an oxidation layer formed on the outer surface of the heating substrate of the first heating portion and/or the heating substrate of the second heating portion by means of heat treatment.

In some embodiments, the diameter of the heating element is 0.05-0.7 mm.

In some embodiments, the resistivity of the heating element is 0.8-1.6 Ohm mm²/m.

In some embodiments, the sleeve is a hollow pipe, a first accommodating cavity for accommodating the heating element is formed inside the sleeve, and the heating element is spaced apart from the inner wall of the first accommodating cavity.

In some embodiments, the heating element is spaced apart from the periphery of the sleeve, and the interior of the sleeve is hollow and forms a second accommodating cavity for accommodating an aerosol generating substrate.

In some embodiments, the sleeve includes a first pipe body that allows light waves to pass through and a second pipe body sleeved on the periphery of the first pipe body;
a gap is reserved between the second pipe body and the first pipe body, and the gap forms a first accommodating cavity for accommodating the heating element; and
the heating element is arranged on the periphery of the first pipe body and is spaced apart from the first pipe body.

In some embodiments, one end of the sleeve is provided with an opening, and both the first free end and the second free end are led out from the opening to the outside of the sleeve.

In some embodiments, the whole heating element is spaced apart from the pipe wall of the sleeve.

In some embodiments, the heating element is arranged without direct contact with the sleeve.

In some embodiments, the thickness of the pipe wall of the sleeve is 0.15 mm to 0.6 mm.

In some embodiments, the spacing between the pipe wall of the sleeve and the heating element is 0.05 mm to 1 mm.

The present disclosure further discloses an aerosol-generating device, including the heating structure of the present disclosure.

The following beneficial effects are obtained when the aerosol-generating device and the heating structure of the present disclosure are implemented. According to the heating structure, the heating element is at least partially bent, and the first free end and the second free end of the heating element can be led out from the same end portion of the sleeve, so that the assembly process of the heating structure can be simplified and assembly costs can be reduced.

In addition, the heating substrate of the heating element generates heat in the powered-on state. The heat may excite the infrared radiating layer to radiate the infrared light waves. The infrared light waves may pass through the sleeve to heat the aerosol generating substrate. When the maximum operating temperature of the heating element reaches above 500° C. or even above 1000° C. (the maximum operating temperature of a conventional HNB heating element is generally around 400° C.), overheating of the aerosol generating substrate is not caused, and the vaping experience can be greatly improved. Meanwhile, preheating time is greatly reduced, thereby greatly improving experience of a consumer. The maximum operating temperature of the heating element in the present disclosure is 500° C. to 1300° C., far higher than the maximum operating temperature of a heating element in the prior art.

To provide a clearer understanding of the technical features, objectives, and effects of the present disclosure, specific implementations of the present disclosure are described with reference to the accompanying drawings.

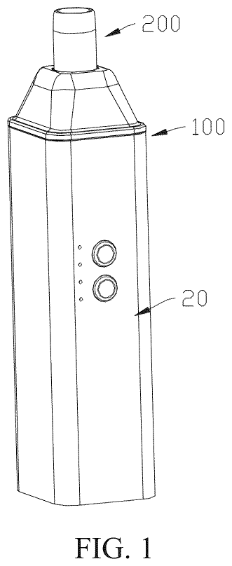

FIG. 1 shows a first embodiment of an aerosol-generating device of the present disclosure. The aerosol-generating device 100 may heat an aerosol generating substrate 200 in a low-temperature heat-not-burn manner, and has good atomization stability and good atomization experience. In some embodiments, the aerosol generating substrate 200 may be arranged in a pluggable manner on the aerosol-generating device 100, and the aerosol generating substrate 200 may be cylindrical. Specifically, the aerosol generating substrate 200 may be a solid material that is in a string shape or a sheet shape and that is made of leaves and/or stalks of plants, and an aroma component may be further added to the solid material.

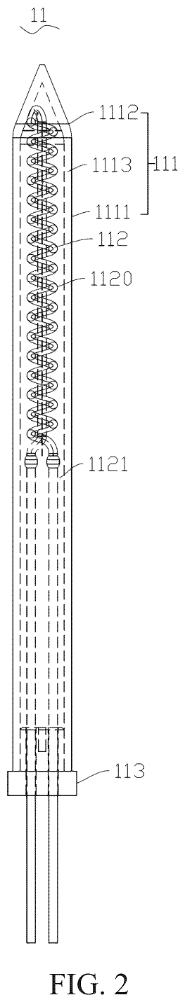

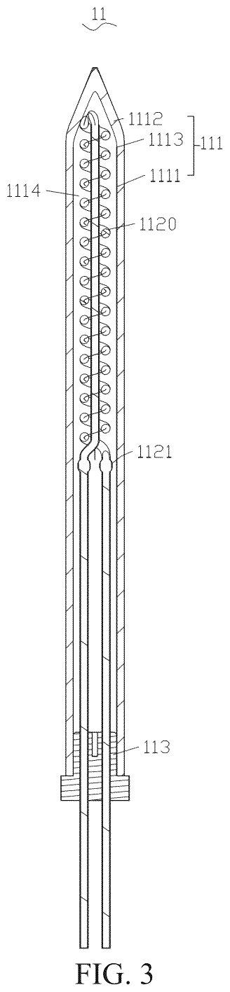

As shown in FIG. 2 and FIG. 3, further, in this embodiment, the aerosol-generating device 100 includes a heating structure 11 and a power supply component 20. The heating structure 11 may be partially inserted into the aerosol generating substrate 200. Specifically, the heating structure 11 may be partially inserted into a substrate section of the aerosol generating substrate 200, and in a powered-on state, generates infrared light waves to heat the substrate section of the aerosol generating substrate 200, to atomize the substrate section and form aerosol. The heating structure 11 has the advantages of a simple structure, high atomization efficiency, strong stability, and long service life. The power supply component 20 is configured to supply power to the heating structure 11. Specifically, in some embodiments, the heating structure 11 is mounted in a shell of the power supply component 20 in a detachable manner, and may be connected to a power supply in the power supply component 20 mechanically and/or electrically. The heating structure 11 is mounted in the shell of the power supply component 20 in a detachable manner, thereby facilitating replacement of the heating structure 11.

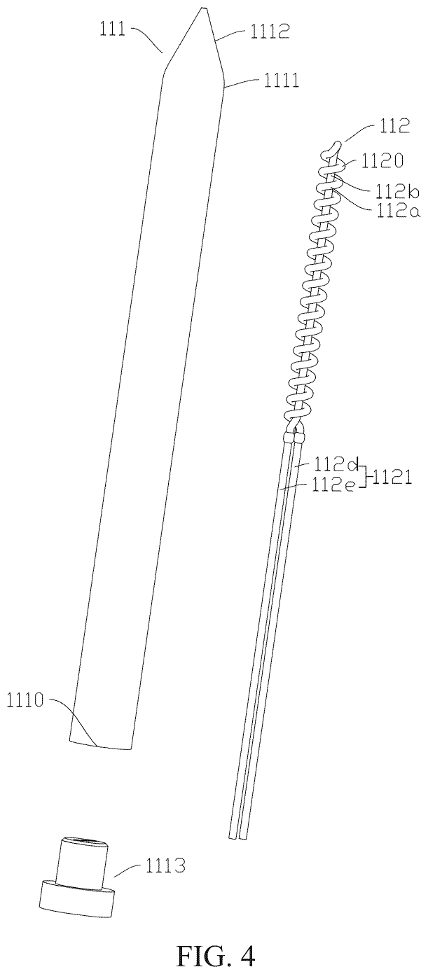

As shown in FIG. 3 and FIG. 4, in this embodiment, the heating structure 11 includes a sleeve 111, a heating element 112, and a base 113. The sleeve 111 covers at least part of the heating element 112, and allows light waves to pass through to the aerosol generating substrate 200. Specifically, in this embodiment, the sleeve 111 allows infrared light waves to pass through, thereby facilitating radiation of the heat from the heating element 112 to heat the aerosol generating substrate 200; and the heating element 112 is spaced apart from the pipe wall of the sleeve 111. The base 113 is arranged at an opening 1110 of the sleeve 111, and is configured to secure the pipe body or seal the opening 1110 of the sleeve 111. The maximum operating temperature of the heating element in the present disclosure is 500° C. to 1300° C., far higher than the maximum operating temperature of a heating element in the prior art, thereby greatly improving the vaping experience, and greatly shortening preheating time.

In this embodiment, the sleeve 111 may be a quartz glass pipe. Certainly, it may be understood that in some other embodiments, the sleeve 111 is not limited to a quartz pipe, and may be made of other window materials, such as infrared transmitting glass, transparent ceramics, or diamond, that allow light waves to pass through.

In this embodiment, the sleeve 111 is a hollow pipe, and has two end portions distributed along the longitudinal direction. Specifically, the sleeve 111 includes a tubular body 1111 having a circular cross section and a pointed top structure 1112 arranged at one end of the tubular body 1111. Certainly, it may be understood that in some other embodiments, the cross section of the tubular body 111 is not limited to a circle. The tubular body 1111 is a hollow structure provided with an opening 1110 at one end. The pointed top structure 1112 is arranged at one end of the tubular body 1111 far away from the opening 1110. The arrangement of the pointed top structure 1112 facilitates insertion of at least part of the heating structure 111 into the aerosol generating substrate 200. In this embodiment, a first accommodating cavity 1113 is formed inside the sleeve 111, and the first accommodating cavity 1113 is a cylindrical cavity. In some other embodiments, the heating element 112 may be spaced apart from the periphery of the sleeve 111, and a second accommodating cavity for accommodating the aerosol generating substrate 200 may be formed inside the sleeve 111.

In this embodiment, the pipe wall of the sleeve 111 is spaced apart from the entire heating element 112. An air gap 1114 is reserved between the inner wall of the sleeve 111 and the heating element 112. The air gap 1114 may be filled with air. Certainly, it may be understood that in some other embodiments, the air gap 1114 may alternatively be filled with a reducing gas or an inert gas. By reserving the air gap 1114, the sleeve 111 and the heating element 112 are kept from direct contact. In some embodiments, the heating element 112 may alternatively be partially spaced apart from the pipe wall of the sleeve 111. Specifically, the radial dimension of a partial section of a heating portion 1120 may be greater than that of another partial section. The radial dimension of the partial section of the heating portion 1120 may be equal to the inner diameter of the sleeve 111, thereby having a position limiting function. Certainly, it may be understood that in some embodiments, the inner side of the pipe wall of the sleeve 111 may partially protrude towards the direction of the heating element 112 to contact the heating element 112, thereby having a position limiting function. Certainly, it may be understood that in some other embodiments, an isolating and positioning structure may be arranged on the heating element 112 or the pipe wall of the sleeve 111, whereby the heating element 112 and the pipe wall of the sleeve 111 are kept from direct contact. For example, a ceramics ring or the like is sleeved on a partial section of the heating element 112. It should be noted that the above-mentioned air gap may refer to a gap accessible to air, and does not mean that air or other gas necessarily exists, and a vacuum state is a form of the air gap.

The temperature at which the entire heating structure 11 heats the aerosol generating substrate 200 may be further configured by configuring the thickness of the pipe wall and the spacing between the heating element 112 and the pipe wall. At the same temperature, as the thickness of the pipe wall increases, the overall irradiance may decrease. Optionally, in some embodiments, the thickness of the pipe wall of the sleeve 111 is 0.15 mm to 0.6 mm. In some embodiments, as the spacing between the heating element 112 and the pipe wall increases, the temperature of the heating structure 11 may gradually decrease. Preferably, in some embodiments, the spacing between the pipe wall of the sleeve 111 and the heating element 12 may be 0.05 mm to 1 mm.

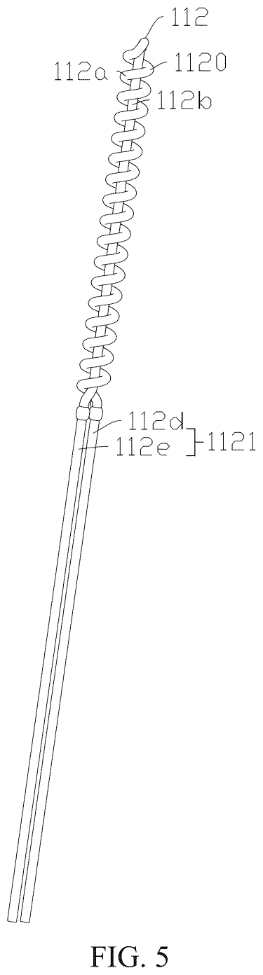

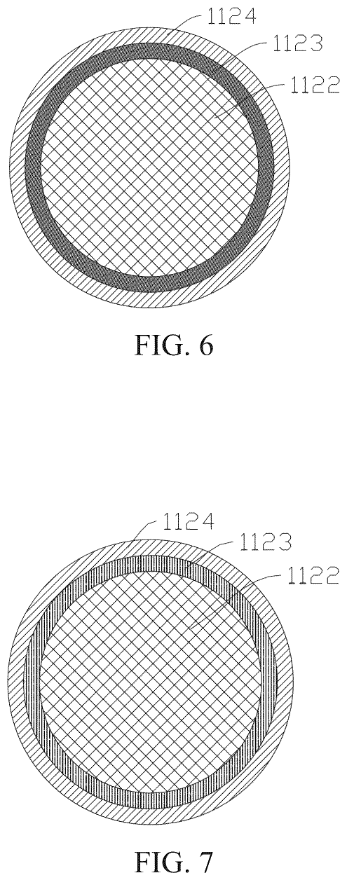

As shown in FIG. 5 and FIG. 6, in this embodiment, the heating element 112 may be one and arranged lengthwise, and has a first free end 112d and a second free end 112e. The first free end 112d and the second free end 112e may be led out from the same end portion of the sleeve 111. In this embodiment, the heating element 112 is a strip with a circular cross section. The heating element 112 is at least partially bent, to form a cylindrical heating portion 1120. Specifically, the heating element 112 may be bent to form a single-spiral cylindrical heating portion 1120. It may be understood that in some other embodiments, the heating element 112 is not limited to a strip, and may be a lengthwise sheet or mesh. The heating portion 1120 is not limited to a cylindrical shape, and may alternatively be in a sheet shape, a strip shape, or a mesh shape. In some other embodiments, the heating element 112 may be wrapped to form a double-spiral structure, an M-type structure, an N-type structure, or a structure in another shape. Certainly, it may be understood that in some other embodiments, the heating element 112 is not limited to one, and may be two or more than two. In a case of two heating elements 112, one ends of the two heating elements 112 may be connected, and the other ends (the ends that are not connected) form free ends. That is, the free ends of the two heating elements 112 correspondingly form the first free end 112d and the second free end 112e. The shape of the heating element 112 is not limited to a cylindrical shape. In some embodiments, the heating element 112 may be in a sheet shape.

In this embodiment, one end of the heating portion 1120 is provided with a conductive portion 1121. The conductive portion 1121 is connected with the heating portion 1120, may be led out from one end portion of the sleeve 111, and may pass through the base 113 to be connected with the power supply component 20 in a conductive manner. The conductive portion 1121 may be two. The two conductive portions 1121 may be arranged at an interval, are respectively connected with the heating portion 1120, and are both led out of the sleeve 111 from one end of the sleeve 111 which is provided with the opening 1110. In this embodiment, the first free end 112d and the second free end 112e of the heating element 112 may form two conductive portions 1121, that is, the first free end 112d of the first heating portion 112a forms one of the conductive portions 1121; and the second free end 112e of the second heating portion 112b forms another conductive portion 1121, and the heating portion 1120 may be integrally formed with the conductive portions 1121. Certainly, it may be understood that in some other embodiments, the conductive portions 1121 may be secured to the first free end 112d and the second free end 112e by means of soldering and form an integral structure with the heating portion 1120. The conductive portion 1121 may be a lead and may be soldered to the heating portion 1120. Certainly, it may be understood that in some other embodiments, the conductive portion 1121 is not limited to the lead, and may be other conductive structures. The first free end 112d and the second free end 112e (that is, the two conductive portions 1121) are led out from the same end portion of the sleeve 111, thereby facilitating assembly of the entire heating structure 11 and simplifying the assembly process. During assembly, the heating structure 11 may be mounted on a support base, and then is in contact with an electrode located in the support base.

In this embodiment, the heating element 112 includes a heating substrate 1122 and an infrared radiating layer 1124. The heating substrate 1122 may generate heat in a powered-on state. The infrared radiating layer 1124 is arranged on the outer surface of the heating substrate 1122. In a powered-on and heating state, the heating substrate 1122 may excite the infrared radiating layer 1124 to generate and radiate infrared light waves. In this embodiment, the heating substrate 1122 and the infrared radiating layer 1124 are distributed concentrically on a cross section of the heating portion 1120.

In this embodiment, the heating substrate 1122 may be entirely cylindrical. Specifically, the heating substrate 1122 may be a heating wire. Certainly, it may be understood that in some other embodiments, the heating substrate 1122 may be not limited to a cylindrical shape, and may be in a sheet shape. That is, the heating substrate 1122 may be a heating sheet. The heating substrate 1122 includes a metal matrix with high-temperature oxidation resistance, and the metal matrix may be a metal wire. Specifically, the heating substrate 1122 may be a metal material with good high-temperature oxidation resistance, high stability, and low tendency to deform, such as a nickel-chromium alloy matrix (e.g. a nickel-chromium alloy wire) or an iron-chromium-aluminum alloy matrix (e.g. an iron-chromium-aluminum alloy wire). In this embodiment, the radial dimension of the heating substrate 1122 may be 0.15 mm to 0.8 mm.

In this embodiment, the heating element 112 further includes an anti-oxidation layer 1123, and the anti-oxidation layer 1123 is formed between the heating substrate 1122 and the infrared radiating layer 1124. Specifically, the anti-oxidation layer 1123 may be an oxidation film; the heating substrate 1122 is subjected to high-temperature heat treatment and a compact oxidation film is generated on the surface of the heating substrate; and the oxidation film forms the anti-oxidation layer 1123. Certainly, it may be understood that in some other embodiments, the anti-oxidation layer 1123 is not limited to the oxidation film formed on the surface of the heating substrate by itself; and in some other embodiments, the anti-oxidation layer 1123 may be an anti-oxidation coating applied to the outer surface of the heating substrate 1122. By forming the anti-oxidation layer 1123, it can be ensured that the heating substrate 1122 is not or rarely oxidized when being heated in an air environment, thereby improving the stability of the heating substrate 1122. Therefore, it is not necessary to vacuumize or fill the first accommodating cavity 1113 with an inert gas or a reducing gas, thereby simplifying the assembly process of the entire heating structure 11 and reducing manufacturing costs. In this embodiment, the thickness of the anti-oxidation layer 1123 may be optionally 1 um to 150 um. When the thickness of the anti-oxidation layer 1123 is less than 1 um, the heating substrate 1122 is easily oxidized. When the thickness of the anti-oxidation layer 1123 is greater than 150 um, heat conduction between the heating substrate 1122 and the infrared radiating layer 1124 is affected.

In this embodiment, the infrared radiating layer 1124 may be an infrared layer. The infrared layer may be an infrared layer-forming substrate that is formed, through high-temperature heat treatment, on the side of the anti-oxidation layer 1123 away from the heating substrate 1122. In this embodiment, the infrared layer-forming substrate may be a silicon carbide substrate, a spinel substrate, or a composite substrate thereof. Certainly, it may be understood that in some other embodiments, the infrared radiating layer 1124 is not limited to the infrared layer. In some other embodiments, the infrared radiating layer 1124 may be a composite infrared layer. In this embodiment, the infrared layer may be formed, by a method such as dipping, spraying, or brushing, on the side of the anti-oxidation layer 1123 which is away from the heating substrate 1122. The thickness of the infrared radiating layer 1124 may be 10 um to 300 um. When the thickness of the infrared radiating layer 1124 is 10 um to 300 um, the infrared light waves emitted by the infrared radiating layer have a better effect, and therefore, the atomization efficiency and the atomization experience of the aerosol generating substrate 200 are optimized. Certainly, it may be understood that in some other embodiments, the thickness of the infrared radiating layer 1124 is not limited to 10-300 um.

In this embodiment, the heating portion 1120 includes a first heating portion 112a and a second heating portion 112b; one ends of the first heating portion 112a and the second heating portion 112b are connected, and the first free end 112d is arranged at the end of the first heating portion 112a that is not connected with the second heating portion 112b; and the second free end 112e is arranged at the end of the second heating portion 112b that is not connected with the first heating portion 112a. In this embodiment, the first heating portion 112a and the second heating portion 112b are of an integrally formed structure, and may be formed by bending one heating element 112. It may be understood that in some other embodiments, the first heating portion 112a and the second heating portion 112b also may have a separate structure, and the first heating portion 112a and the second heating portion 112b may be two heating elements 112. It may be understood that in some other embodiments, the second heating portion 112b may be omitted, and may be replaced by a non-heating conducting rod.

In this embodiment, the heating portion 1120 is formed in a single-spiral winding manner. Specifically, the second heating portion 112b may be linear. The first heating portion 112a may be wrapped on the periphery of the second heating portion 112b along the circumferential direction and the longitudinal direction of the second heating portion 112b by taking the second heating portion 112b as a center rod. The heating portion 1120 may include a plurality of bent segments 112c, that is, the first heating portion 112a includes a plurality of bent segments 111c. Certainly, it may be understood that the bent segments 111c are not limited to being a plurality of segments, and may alternatively be one segment. In this embodiment, the plurality of bent segments 112c are arranged at intervals and are equally distributed in the longitudinal direction of the second heating portion 112b. Certainly, it may be understood that in some other embodiments, the plurality of bent segments 112c are not limited to equal distribution. In this embodiment, for a heating element made of the same material and having a uniform diameter, the distribution of an entire temperature field of the heating portion 1120 may be controlled by adjusting the distribution of the spacing between the bent segments 112c, that is, by adjusting the spiral spacing, thereby improving heating stability and improving atomization uniformity of the aerosol generating substrate. It should be noted that the distribution of the entire temperature field is correlated with the density of the plurality of bent segments 112c, and a wrapping manner in different density levels of the bent segments 112c may be selected according to a requirement for the distribution of the temperature field and a heating state in the heating process of the entire aerosol generating substrate.

Usually, the smaller spiral spacing indicates the greater heat and the higher temperature generated at the same length, and the stronger infrared radiation. However, for the two ends, because the heat sink area is larger than that in the middle, the temperature is lower in the same spiral spacing. To achieve overall temperature uniformity, the spiral spacing of the two ends is small and the spiral spacing of the middle is large. However, the atomization effect of the aerosol generating substrate 200 is not necessarily the optimal in a case of a uniform temperature field, and further may be influenced by air flow and other factors. Therefore, different spiral structures may be arranged to control the temperature field.

Certainly, it may be understood that in some other embodiments, the distribution of the entire temperature field may be controlled by controlling resistance. The resistance may be controlled by selecting a material of the heating element 112 or controlling different diameters. That is, a heating element 112 made of a corresponding material and having a corresponding diameter may be selected as required. In this embodiment, the resistivity may be controlled to be 0.8-1.6 Ohm mm²/m. Optionally, the diameter of the heating element 112 may be 0.05-0.7 mm.

In this embodiment, the outer wall of the heating element 112 may be entirely provided with an insulation structure, that is, outer walls of the first heating portion 112a and the second heating portion 112b are provided with an insulation structure. Certainly, it may be understood that the insulation structure may alternatively be arranged only on the outer wall of the first heating portion 112a or the outer wall of the second heating portion 112b. By means of the insulation structure, the first heating portion 112a and the second heating portion 112b may be in insulated configuration. In this embodiment, the insulation structure may be an air gap. The air gap may be formed by vaporizing an insulating coating arranged between the first heating portion 112a and the second heating portion 112b. In this embodiment, the insulating coating may be applied to the outer surface of the first heating portion 112a and the outer surface of the second heating portion 112b. Certainly, it may be understood that in some other embodiments, the insulating coating may alternatively be only applied to the outer surface of the first heating portion 112a or the outer surface of the second heating portion 112b. In some other embodiments, the insulation structure may alternatively be only an insulation layer applied to the outer surface of the first heating portion 112a and/or the outer surface of the second heating portion 112b, without vaporization treatment.

In some embodiments, the insulating coating may be vaporized under a high temperature, thereby forming an air gap between the first heating portion 112a and the second heating portion 112b and achieving insulation. In this embodiment, the insulating coating may be Teflon. Specifically, the entire outer surface of the heating element 112 may be covered with Teflon, and then the heating element is tightly wrapped into a spiral shape, whereby 2 Teflon layers with a thickness equivalent to two wall-thicknesses are formed between the first heating portion 112a and the second heating portion 112b. After the heating portion 1120 is wrapped and directed, the high temperature may cause the Teflon to be vaporized, thereby forming an air gap between the first heating portion 112a and the second heating portion 112b and achieving insulation.

It may be understood that in some other embodiments, the insulation structure is not limited to the insulating coating. In some other embodiments, the insulation structure may be an insulating sleeve, and the insulating sleeve may be sleeved on the periphery of the second heating portion 112b, to prevent direct contact between the second heating portion 112b and the first heating portion 112a and avoid local conduction or breakdown. Certainly, it may be understood that the insulating sleeve may alternatively be sleeved on the periphery of the first heating portion 112a, and the insulating sleeve may be a micro-ceramics pipe, a glass pipe, or other high-temperature-resistant insulating materials.

In some embodiments, the outer surface of the heating substrate 1122 of the first heating portion 112a and the second heating portion 112b is subjected to heat treatment, an oxidation layer 1123 is formed on the outer surface of the heating substrate itself, and insulation of the first heating portion 112a and the second heating portion 112b may be enhanced to play a role in protecting the heating substrate 1122. That is, the insulation structure may further include the oxidation layer 1123.

FIG. 7 shows a second embodiment of the aerosol-generating device of the present disclosure. A difference between the second embodiment and the first embodiment lies in that the infrared radiating layer 1124 is a composite infrared layer, and the composite infrared layer may be a composite formed by combining an infrared layer-forming substrate with a bonding body for bonding with the anti-oxidation layer 1123. Specifically, the bonding body may be glass powder, and the composite infrared layer may be a glass powder composite infrared layer. The glass powder may be melted at a high temperature to bond the anti-oxidation layer 1123 with the infrared layer-forming substrate, and to block a gap of the infrared layer-forming substrate, thereby further improving breakdown resistance.

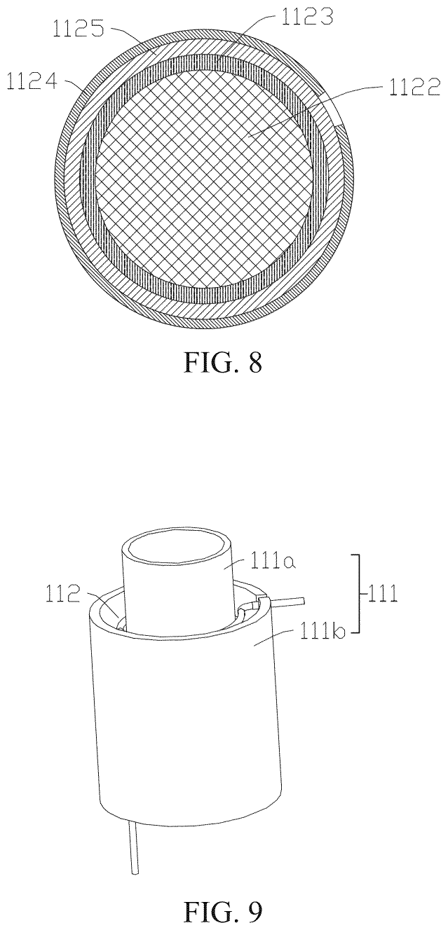

FIG. 8 shows a third embodiment of the aerosol-generating device of the present disclosure. The third embodiment differs from the first embodiment in that the heating element 112 further includes a bonding layer 1125 arranged between the anti-oxidation layer 1123 and the infrared radiating layer 1124; and the bonding layer 1125 may be configured to prevent local breakdown of the heating substrate 1122, and further to improve the bonding force between the anti-oxidation layer 1123 and the infrared radiating layer 1124. In some embodiments, a bonding body in the bonding layer 1125 may be glass powder, that is, the bonding layer 1125 may be a glass powder layer.

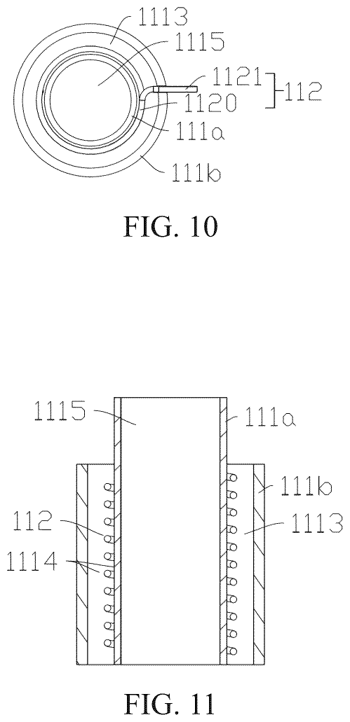

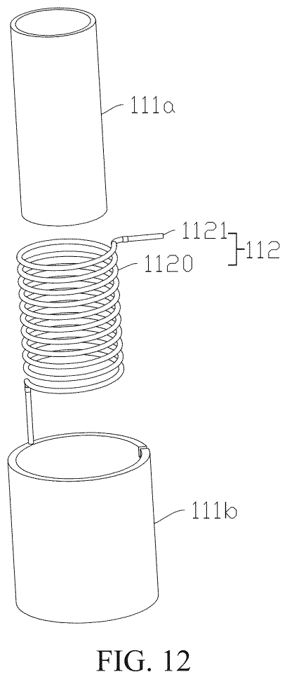

FIG. 9 to FIG. 12 show a fourth embodiment of the aerosol-generating device of the present disclosure. The fourth embodiment differs from the first embodiment in that the heating structure 11 is not limited to being partially inserted into the aerosol generating substrate 200 to heat the aerosol generating substrate 200. In this embodiment, the heating structure 11 may be sleeved on the periphery of a substrate section of the aerosol generating substrate 200, and heats an aerosol generating substrate in the aerosol generating substrate 200 in a peripheral heating manner. In this embodiment, the second heating portion 112b may be omitted.

In this embodiment, the sleeve 111 includes a first pipe body 111a and a second pipe body 111b; and the first pipe body 111a is a hollow structure with two ends communicated with each other. The first pipe body 111a may be cylindrical, and the inner diameter of the first pipe body 111a may be slightly greater than the outer diameter of the aerosol generating substrate 200. A second accommodating cavity 1115 may be formed inside the first pipe body 111a, and is configured to heat the substrate section of the aerosol generating substrate 200. The axial length of the first pipe body 111a may be greater than that of the second pipe body 111b. The second pipe body 111b may be sleeved on the periphery of the first pipe body 111a. The second pipe body 111b may be cylindrical. The radial dimension of the second pipe body 111b may be greater than that of the first pipe body 111a. That is, a gap is reserved between the second pipe body 111b and the first pipe body 111a. The gap may form a first accommodating cavity 1113. The first accommodating cavity 1113 is configured to accommodate a heating element 112. In some embodiments, the heating element 112 is wrapped on the periphery of the first pipe body 111a, and an air gap 1114 is reserved between the inner wall of the second pipe body 111b and the outer wall of the first pipe body 111a, thereby forming a particular temperature difference between the inner wall of the first accommodating cavity 1113 and the heating element 112 and achieving a heat insulation function. In some embodiments, a reflective layer may be arranged on the inner wall of the second pipe body 111b, and is configured to reflect heat from the heating element 112 and radiate the heat from the heating element 112 to the aerosol generating substrate 200, thereby enhancing the energy efficiency of the heating element 112.

In some other embodiments, the heating element 112 is not limited to being entirely spaced apart from the first pipe body 111a or the second pipe body 111b. In some other embodiments, the heating element 112 may be partially spaced apart from the first pipe body 111a. The radial dimension of the partial section of the heating portion 1120 may be equivalent to the outer diameter of the first pipe body 111a, and the partial section of the heating portion 1120 may have a position limiting function. In some embodiments, the heating element 112 may be partially spaced apart from the second pipe body 111b, and the radial dimension of the partial section of the heating portion 1120 may be equivalent to that of the second pipe body 111b.

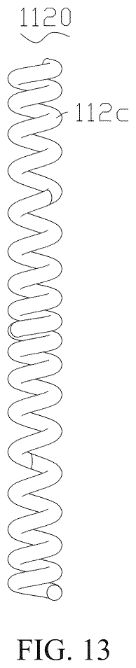

FIG. 13 shows a fifth embodiment of the aerosol-generating device of the present disclosure. A difference between the fifth embodiment and the first embodiment lies in that the plurality of bent segments 112c may be densely and sparsely distributed alternately.

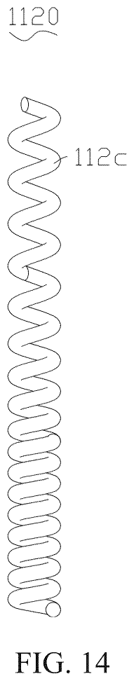

FIG. 14 shows a sixth embodiment of the aerosol-generating device of the present disclosure. A difference between the sixth embodiment and the first embodiment lies in that the plurality of bent segments 112c may be distributed sparsely first and then densely.

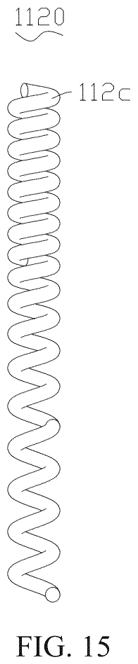

FIG. 15 shows a seventh embodiment of the aerosol-generating device of the present disclosure. A difference between the seventh embodiment and the first embodiment lies in that the plurality of bent segments 112c may be distributed densely first and then sparsely.

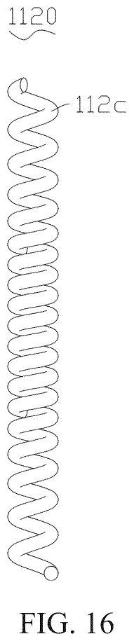

FIG. 16 shows an eighth embodiment of the aerosol-generating device of the present disclosure. A difference between the eighth embodiment and the first embodiment lies in that the plurality of bent segments 112c may be distributed sparsely first, then densely, and sparsely finally.

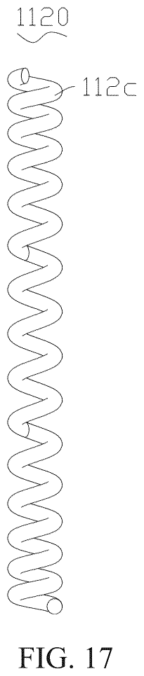

FIG. 17 shows a ninth embodiment of the aerosol-generating device of the present disclosure. A difference between the ninth embodiment and the first embodiment lies in that the plurality of bent segments 112c may be distributed densely first, then sparsely, and densely finally.

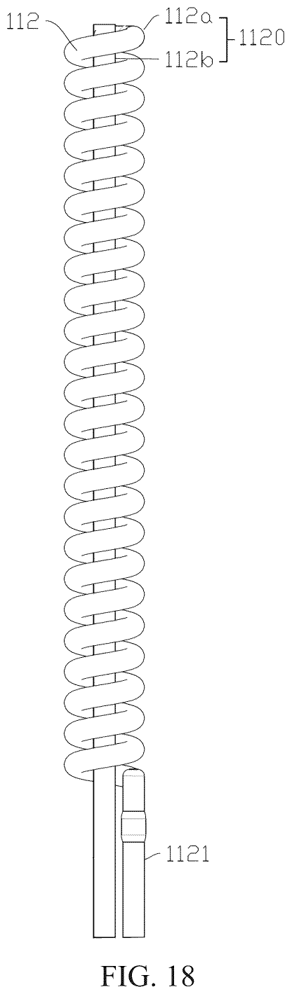

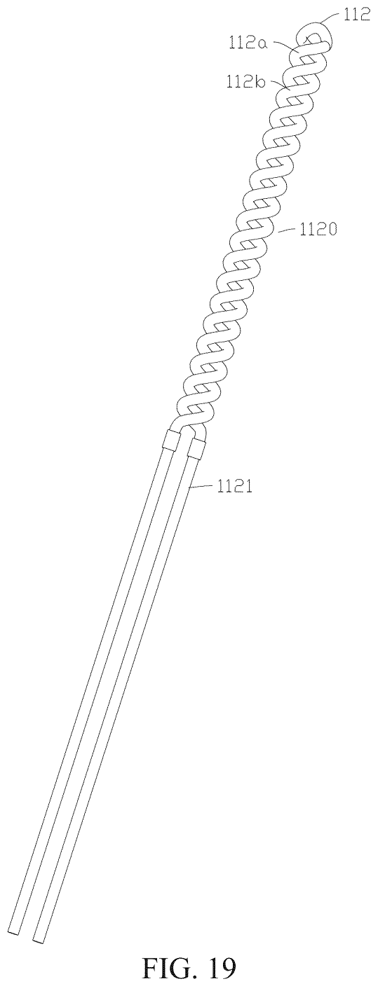

FIG. 18 shows a tenth embodiment of the aerosol-generating device of the present disclosure. A difference between the tenth embodiment and the first embodiment lies in that the first heating portion 112a and the second heating portion 112b may have a separate structure. The first heating portion 112a and the second heating portion 112b are two independent heating elements 112. Certainly, it may be understood that the second heating portion 112b may alternatively be replaced by a non-heating conducting rod.

FIG. 19 shows an eleventh embodiment of the aerosol-generating device of the present disclosure. A difference between the eleventh embodiment and the first embodiment lies in that the first heating portion 112a and the second heating portion 112b of the heating element 112 may be wrapped in a double-spiral winding manner to form a double-spiral heating portion 1120.

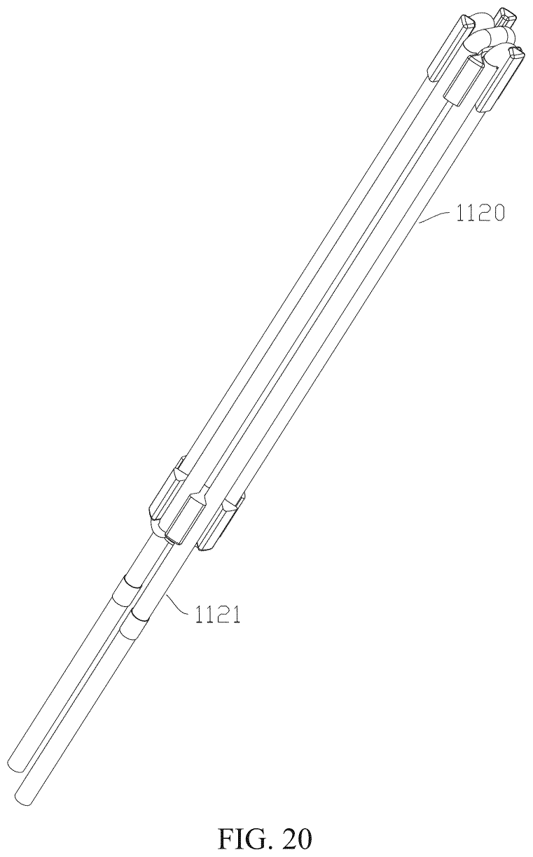

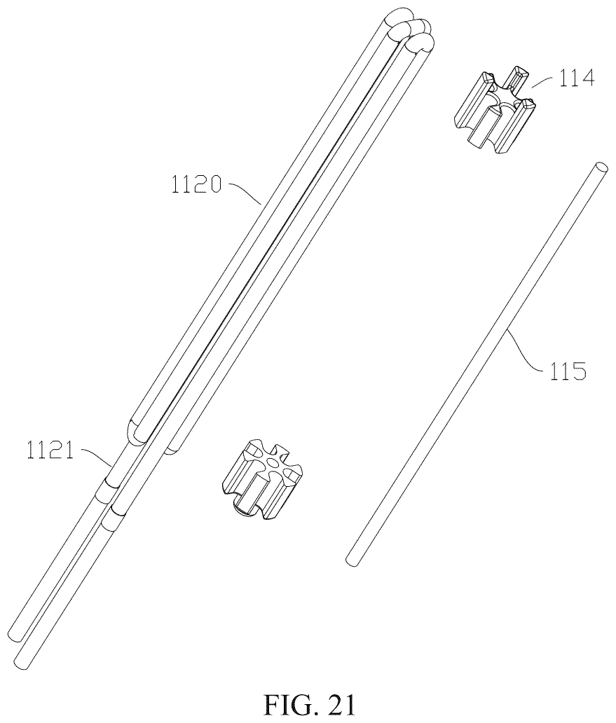

FIG. 20 and FIG. 21 show a twelfth embodiment of the aerosol-generating device of the present disclosure. A difference between the twelfth embodiment and the first embodiment lies in that the heating element 112 may form the heating portion 1120 in an M winding manner. Specifically, the heating structure 11 may include a bobbin 114, two bobbins 114 may be arranged, the two bobbins 114 may be arranged at an interval, and the heating element 112 may be wrapped on the periphery of the two bobbins 114. The two bobbins 114 have the same structures and radial dimensions, whereby the dimension of the entire heating portion 1120 in the radial directions of the bobbins 114 is evenly distributed in the longitudinal direction of the heating portion 1120. In this embodiment, the heating structure 11 further includes a support bar 115, and the support bar 115 may be arranged between the two bobbins 114, to provide support.

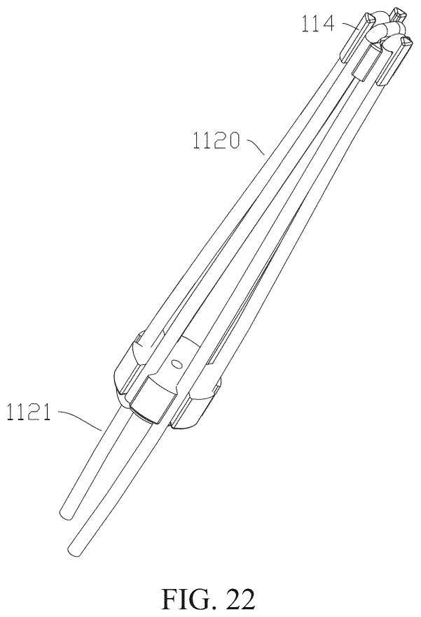

FIG. 22 shows a thirteenth embodiment of the aerosol-generating device of the present disclosure. A difference between the thirteenth embodiment and the second embodiment lies in that the radial dimension of one bobbin 114 is smaller than that of the other bobbin 114, whereby the entire heating portion 1120 may have a pyramidal shape, and the conductive portion 1121 may pass through the bobbin 114 having the larger radial dimension.

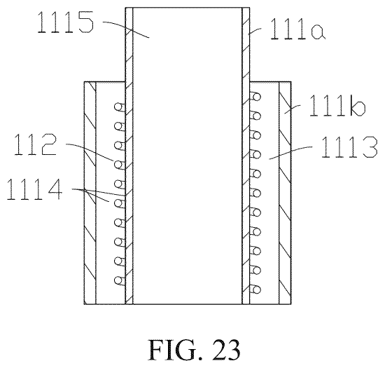

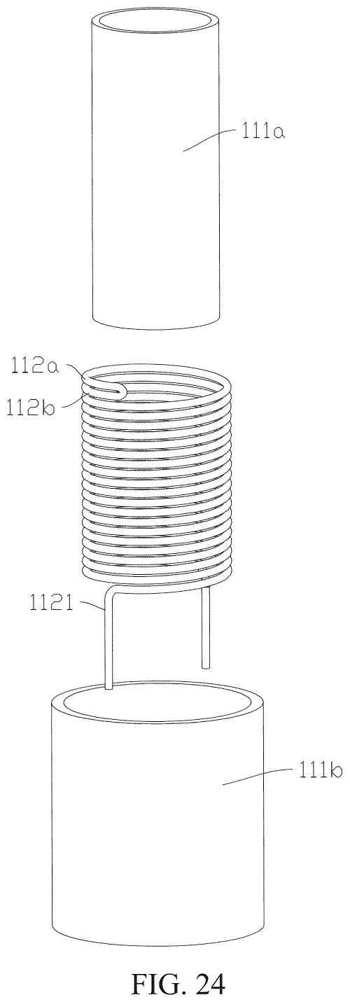

FIG. 23 and FIG. 24 show a fourteenth embodiment of the aerosol-generating device of the present disclosure. A difference between the fourteenth embodiment and the fourth embodiment lies in that the heating element 112 forms the heating portion 1120 in a double-spiral winding manner.

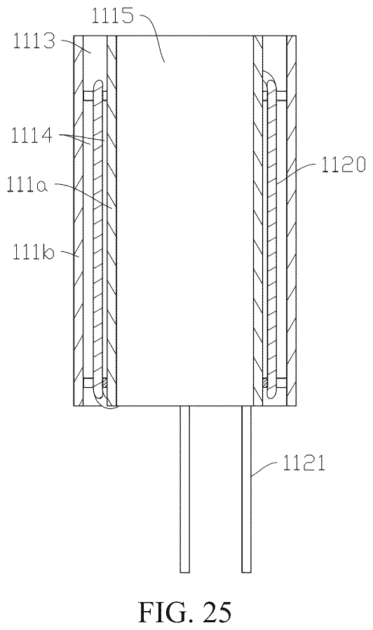

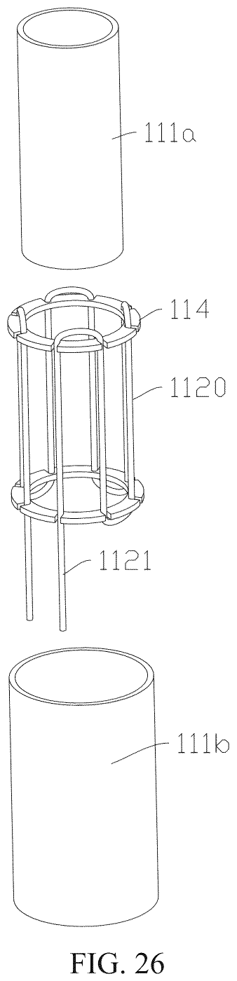

FIG. 25 and FIG. 26 show a fifteenth embodiment of the aerosol-generating device of the present disclosure. A difference between the fifteenth embodiment and the fourteenth embodiment lies in that the heating element 112 forms the heating portion 1120 in an M winding manner.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A heating structure, comprising:
a sleeve;
a heating element at least partially spaced apart from the sleeve, the heating element comprising a heating substrate configured to generate heat in a powered-on state; and
an infrared radiating layer arranged on an outer surface of the heating substrate and configured to radiate infrared light waves,
wherein the sleeve is configured to be allow the infrared light waves to pass through,
wherein the heating element is at least partially bent and has a first free end and a second free end,
wherein the sleeve has two end portions distributed along a longitudinal direction, and
the first free end and the second free end are led out from a same end portion of the sleeve.

2. The heating structure of claim 1, wherein the heating element comprises a plurality of bent segments, and
wherein the plurality of bent segments are arranged at intervals.

3. The heating structure of claim 2, wherein the plurality of bent segments are equally distributed.

4. The heating structure of claim 2, wherein the plurality of bent segments are distributed densely and sparsely alternately.

5. The heating structure of claim 2, wherein the plurality of bent segments are distributed sparsely first and then densely.

6. The heating structure of claim 2, wherein the plurality of bent segments are distributed densely first and then sparsely.

7. The heating structure of claim 2, wherein the plurality of bent segments are distributed sparsely first, then densely, and finally sparsely.

8. The heating structure of claim 2, wherein the plurality of bent segments are distributed densely first, then sparsely, and finally densely.

9. The heating structure of claim 1, wherein the heating element comprises a first heating portion and a second heating portion, and
wherein the first heating portion is wrapped on a periphery of the second heating portion.

10. The heating structure of claim 9, wherein the second heating portion has a linear shape, and
wherein the first heating portion comprises at least one bent segment.

11. The heating structure of claim 9, wherein the first free end is arranged at one end of the first heating portion and forms a conductive portion, and
wherein the second free end is arranged at one end of the second heating portion and forms another conductive portion.

12. The heating structure of claim 9, wherein the first heating portion and the second heating portion are of a separate structure.

13. The heating structure of claim 9, wherein the first heating portion and the second heating portion are of an integral structure.

14. The heating structure of claim 9, wherein the first heating portion and the second heating portion are in insulated configuration, and/or
wherein the first free end and the second free end are in insulated configuration.

15. The heating structure of claim 9, wherein an outer wall of the first heating portion and/or an outer wall of the second heating portion are/is provided with an insulation structure.

16. The heating structure of claim 15, wherein the insulation structure comprises an air gap, or an insulation layer applied to an outer surface of the first heating portion and/or an outer surface of the second heating portion.

17. The heating structure of claim 15, wherein the insulation structure comprises an oxidation layer formed on an outer surface of the heating substrate of the first heating portion and/or the heating substrate of the second heating portion by heat treatment.

18. The heating structure of claim 1, wherein a diameter of the heating element is 0.05-0.7 mm.

19. The heating structure of claim 1, wherein a resistivity of the heating element is 0.8-1.6 Ohm mm²/m.

20. The heating structure of claim 1, wherein the sleeve comprises a hollow pipe, a first accommodating cavity configured to accommodate the heating element being formed inside the sleeve, and
wherein the heating element is spaced apart from an inner wall of the first accommodating cavity.

21. The heating structure of claim 1, wherein the heating element is spaced apart from a periphery of the sleeve, and
wherein an interior of the sleeve is hollow and forms a second accommodating cavity configured to accommodate an aerosol generating substrate.

22. The heating structure of claim 1, wherein the sleeve comprises a first pipe body configured to allow light waves to pass through and a second pipe body sleeved on a periphery of the first pipe body,
wherein a gap is reserved between the second pipe body and the first pipe body, and the gap forms a first accommodating cavity configured to accommodate the heating element, and
wherein the heating element is arranged on a periphery of the first pipe body and is spaced apart from the first pipe body.

23. The heating structure of claim 1, wherein one end of the sleeve is provided with an opening, and
wherein both the first free end and the second free end are led out from the opening to an outside of the sleeve.

24. The heating structure of claim 1, wherein the heating element is entirely spaced apart from a pipe wall of the sleeve.

25. The heating structure of claim 1, wherein the heating element is arranged without direct contact with the sleeve.

26. The heating structure of claim 1, wherein a thickness of the pipe wall of the sleeve is 0.15 mm to 0.6 mm.

27. The heating structure of claim 1, wherein a spacing between the pipe wall of the sleeve and the heating element is 0.05 mm to 1 mm.

28. An aerosol-generating device, comprising:
the heating structure of claim 1.
